(19) United States
(12) Patent Application Publication
(10) Pub. No.: US 2010/0164863 A1
(43) Pub. Date: Jul. 1, 2010

(54) Systems, Software, Apparatus and Methods for Managing Out-of -Home Displays

(75) Inventors: James A. Tunick, New York, NY (US); Tony Rizzaro, Harrison, NY (US); Eric Alini, Harrison, NY (US)

Correspondence Address: DAVID P. LENTINI, 53 Clark Road, North Berwick, ME, 03906-6310, US

(73) Assignee: StudioIMC, New York, NY (US)

(21) Appl. No.: 12/509,208

(22) Filed: Jul. 24, 2009

Related U.S. Application Data
(60) Provisional application No. 61/083,362, filed on Jul. 24, 2008.

(51) Int. Cl. G06F 13/14; G09G 5/00

(52) U.S. Cl. 345/156; 345/520

(57) ABSTRACT

Systems, methods, apparatus, and software for monitoring and managing out-of-home (“OOH”) displays are provided. In one aspect, a system for monitoring an OOH display includes an OOH display device configure to display content to at least one subject. An interaction detector is configured to detect at least one interaction between the OOH display device and a subject, and provide data about such interaction. An input mechanism accepts input signals from the subject, and a display controller device accepts signals from the subject and OOH display device. A data processing and routing mechanism processes and exchanges the data.

### BACKGROUND OF THE INVENTION

1.1 Field of the Invention

The present invention provides systems, apparatus, software, and methods for managing displays, and more particularly, for displays used in out-of-home (“OOH”) presentations. Still more particularly, the systems, apparatus, software, and methods provided by the present invention can be used to manage the content of, and collect data from, interactive OOH displays. The present invention has applications in the fields of computer science, computer networking, and business methods.

1.2 The Related Art

Out-of-home advertising has been one of the fastest-growing segments of the media industry, expanding at double-digit rates every year from 2001 to 2006 and posting compound annual growth of 22.6 percent according to a PQ Media study. Marketers and retailers in America annually spend over eight billion dollars on point-of-purchase (“PoP”) advertising, and the growth of this category of marketing expenditure over the last few years has remained steady. New retail categories (i.e., drug stores and mass merchandisers) have been joining what was traditionally more of a supermarket business; one example of this trend is the appearance of in-store TV networks, now in Wal-Mart, Sears, Best Buy and other so-called big-box retailers. Wal-Mart delivers an unprecedented audience of 130 million shoppers in a four week period, putting their display network just behind the major networks such as NBC, CBS, ABC and Fox. The digital signage market is expected to enjoy double-digit growth in the coming years. In 2006 Wal-Mart announced that it will enhance its in-store TV by running different ads in different departments rather than the same ad store-wide. The reason for this growth is not surprising: brand recall studies by Nielsen have shown that TV-based OOH advertising delivered a brand recall score of 66 versus an average score of 24 for in-home TV advertising.

Despite the growth of PoP and the studies that indicate its general value, there remains a need to manage the content on these displays, especially the interactive content, and provide ways to identify meaningful interaction with displays by viewers. Some metrics, such as monthly sales figures, give marketers only a crude indication of the success of total marketing and sales efforts, but provide little useful information on the effectiveness of OOH marketing. For example, sales figures do not pinpoint which areas of investment are contributing to company marketing and branding goals. Other metrics, such as click tracking, use software to track user interaction with certain ads, thus allowing website owners to sell ad space based on a so-called “pay-per-click” business model. Advertising campaign management software having integrated click-tracking metrics record exactly which ads people click on, gathering valuable information about viewer preferences. Once given the data, advertisers can choose to continue or modify their advertisements. (As used herein, the term “interaction” refers to engagement, action, or participation by any person with any given display or point-of-purchase and signage through video tracking, cell phone, voice, or any other interface.) Other data about the interaction can also be gathered such as the length of the interaction, the intensity of the interaction, the number of con-current impressions and other metrics. Pay-per-click advertising metrics have made it possible for an increasing number of marketers to better understand the effectiveness of their ads and promotions in almost any target market at any time. The increase in the amount of information about user interest in ads and promotions has advantageously led to, among other things, more effective marketing with higher returns.

To provide successful OOH marketing strategies and tactics, marketers must be able to schedule interactive content and assimilate large amounts of data to recognize trends and change interactive content accordingly. Screen space on televised signage networks and other out-of-home advertising is often an important factor for marketers when they are looking to place targeted and effective content. Many marketers use digital displays for advertising on buildings and billboards as well as in malls, building lobbies, subways, stores, clubs, and elsewhere; this enables them to deliver messages to very specific audiences. In addition, to be successful in today's information-intensive markets marketers often need to have more efficient software tools and data-gathering techniques in order to have the most optimal marketing campaigns that appeal to their target demographic. Therefore, many marketers use technologies like cookies and Web software to control advertising campaigns as well as to record information about user interaction with those advertisements. Nevertheless, the out-of-home industry has not yet adopted a standard measurement or control mechanism for OOH marketing. Some existing software packages enable scheduling of video clips and standard advertising spots. Other software such as IMCTV (available from StudioIMC of New York, N.Y.) provide such scheduling in addition to more informed interactive content management.

Despite its great utility and success, current IMCTV implementations allow only system administrators to schedule interactive content and standard video content while also measuring the viewer interaction. Marketers may miss important information about potential customers and campaign success without a relatively easy ability to control their interactive advertising based on interaction data. Thus, it would be beneficial to provide systems, software, apparatus, and methods that marketers can use to improve their management and assessment of the value of OOH advertising. The present invention meets these and other needs.

### 2 SUMMARY OF EMBODIMENTS OF THE INVENTION

In one embodiment, the present invention provides a system for monitoring and managing out-of-home (OOH) displays. In one embodiment, the system comprises an OOH display device configured to display content to at least one subject. The OOH display device includes an interaction detector that is configured to detect at least one instance of an interaction between the OOH display device and a subject and provide interaction data based at least in part on such detection. The system also comprises an input mechanism configured to accept input signals from a subject. The system further comprises a display controller device configured to accept data from the OOH display device and the input device. The system also comprises a data processing and routing mechanism, the data processing and routing mechanism that is configured to process and exchange data with the OOH display device, input mechanism, and display controller device

In some embodiments, the input mechanism is a mobile device. In more specific embodiments, the mobile device is a cellular phone or a personal digital assistant.

In other embodiments, interaction detector is configured to receive gesture, voice, or gaze interaction information. In still other embodiments, the data processing and routing mechanism is configured to receive data from the OOH display device and the input mechanism, and relay the data to the display controller. In more specific embodiments, the data processing and routing mechanism is configured to receive data from the display controller, and relay the data to the OOH display device and the input mechanism. In still more specific embodiments, the display controller is configured to control the content of the OOH display device.

In other embodiments, the data processing and routing mechanism is configured to receive data from the display controller, and relay the data to the OOH display device and the input mechanism. In yet other embodiments, the display controller is configured to control the content of the OOH display device. In more specific embodiments, the display controller is configured to control the content of the OOH display device in response to data received from the data processing and routing mechanism.

In another aspect, the present invention provides a method for controlling the content of an OOH display device. In some embodiments, these methods comprise: providing a data processing and routing mechanism, wherein the data processing and routing mechanism is configured to process and exchange data with an OOH display device, an input mechanism, and a display controller, wherein the OOH display device is configured to display content to at least one subject, the OOH display device including an interaction detector, the interaction detector being configured to detect at least one instance of an interaction between the OOH display device and a subject and provide interaction data based at least in part on the detection, the input mechanism is configured to accept input signals from a subject, and the display controller device is configured to accept data from the OOH display device and the input device; receiving data from at least one of the OOH display device, the input mechanism, and the display controller device at the data processing and routing mechanism; and relaying data to at least one of the OOH display device, the input mechanism, and the display controller device.

Some embodiments of the methods of the invention further including processing the data with the processing and routing mechanism; more specific embodiments, further including processing data received at the data processing and routing mechanism from at least one of the OOH display device and the input mechanism, and forwarding the processed data to the display controller device. Still more specific embodiments, further including forwarding data received at the data processing and routing mechanism from the display controller device to at least one of the OOH display device and the input mechanism. Yet more specific embodiments further including changing the display content in response to the data.

In other embodiments, the above-described methods further including forwarding data received at the data processing and routing mechanism from the display controller device to at least one of the OOH display device and the input mechanism. In more specific embodiments, the methods further including changing the display content in response to the data.

In another aspect, the present invention provides methods for providing an interactive OOH display, comprising: providing a data processing and routing mechanism, the data processing and routing mechanism being configured to process and exchange data with the OOH display device, the input mechanism, and the display controller, wherein the OOH display device is configured to display content to at least one subject, the OOH display device including an interaction detector, the interaction detector being configured to detect at least one instance of an interaction between the OOH display device and a subject and provide interaction data based at least in part on the detection, the input mechanism is configured to accept input signals from a subject, and the display controller device is configured to accept data from the OOH display device and the input device; displaying interactive content on the OOH display device to the subject; receiving data from at least one of the OOH display device and the input mechanism device at the data processing and routing mechanism in response to the interactive content; relaying the data to the display controller device; and changing the interactive content on the OOH display device in response to the data.

In some embodiment, the methods further comprising processing the data received from at least one of the OOH display device and the input mechanism device at the data processing and routing mechanism in response to the interactive content with the data processing and routing mechanism prior to the relaying, whereby at least a portion of the data relayed to the display control device has been processed by the data processing and routing mechanism. In more specific embodiments, the methods further include receiving data from the display controller device and relaying the data received from the controller device to the OOH display device, and changing the interactive content in response to receiving the data at the OOH display device.

### 3 BRIEF DESCRIPTION OF THE DRAWINGS

Exemplary embodiments of the present invention are described herein with reference to the following drawings, in which:

FIG. 1 is a conceptual diagram illustrating a system for managing OOH interactive displays in accordance with one embodiment of the invention.

FIG. 2 is a block diagram illustrating an example system for recording interaction data using gaze tracking in a retail advertising environment in accordance with one embodiment of the invention.

FIG. 3 are block diagrams illustrating an example system for recording interaction data using gaze tracking in a retail advertising environment in accordance with one embodiment of the invention.

FIGS. 4A and 4B are block diagrams of a media player client device and monitoring client device with a number of layers defining different stages that can be used to implement the example embodiments in accordance with one embodiment of the invention.

FIGS. 5A-5C are flow diagrams illustrating operation and function of a possible implementation of the embodiments for tracking interactions across numerous displays and billing clients according to one example embodiment. FIG. 5A illustrates on exemplary embodiment for using interaction information to control an OOH display in accordance with the invention. FIG. 5B is a continuation of the illustration in FIG. 5A. FIG. 5C is a representation of an implementation of an invoice that would be generated based on impression information and other metrics about consumers contained in the report data in accordance with one embodiment of the invention.

FIGS. 6-11 are diagrams illustrating methods for operation and management of interactive content and measurement of a network of interactive displays in accordance with various embodiments of the invention.

FIG. 6 illustrates an exemplary method for determining unique “engagements” or “interactions” between a subject and an OOH display in accordance with the present invention.

FIG. 7 illustrates an exemplary method for controlling the system of the invention using a Web Interface and Control Panel in accordance with the present invention.

FIG. 8 illustrates an exemplary method for the operation of the Core Framework in accordance with the present invention.

FIG. 9 illustrates an exemplary process for detecting a subject's interaction with an OOH display in accordance with the present invention.

FIG. 10 illustrates an exemplary embodiment of a system for monitoring and managing an OOH display in accordance with the present invention.

FIG. 11 illustrates a process for controlling an OOH display in accordance with the present invention.

### 4 DETAILED DESCRIPTION OF SOME EMBODIMENTS OF THE INVENTION

### 4.1 Architecture for OOH Display Control and Monitoring Systems

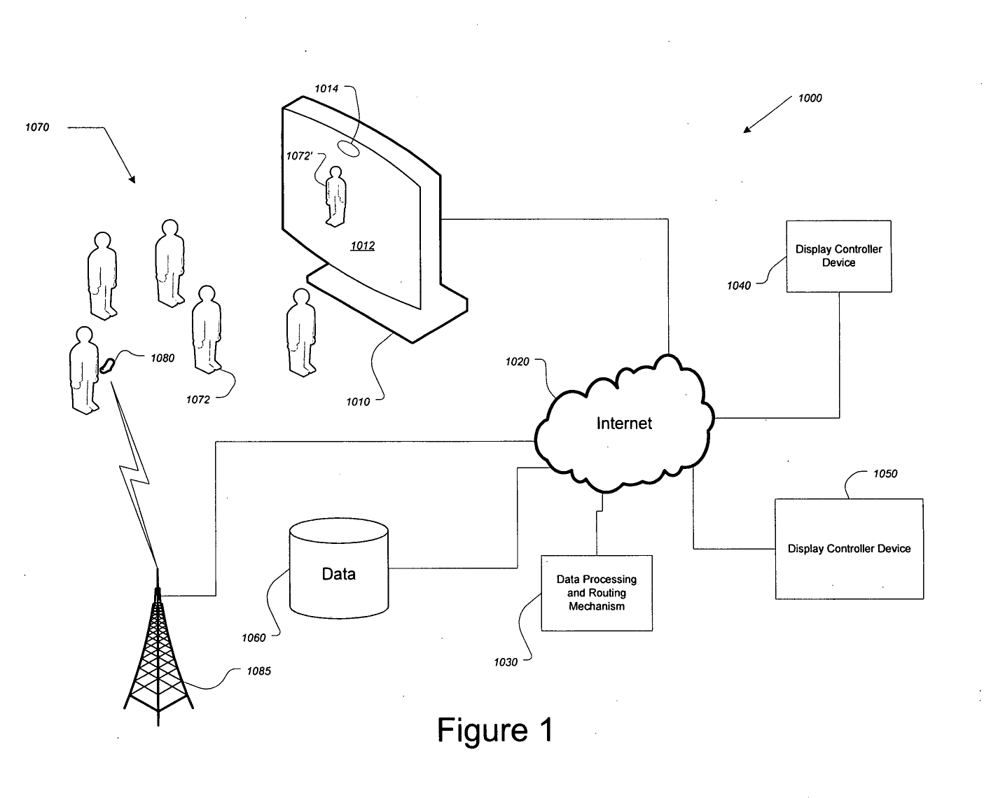

FIG. 1 illustrates one embodiment of a system for controlling and managing content and interactions of an OOH in accordance with the present invention at 1000. An OOH device 1010 provides an out-of-home display using a viewing region 1012 that can be viewed or otherwise perceived by a target audience, including random passers-by, also referred to herein as “subjects”. The content displayed by OOH device 1010 includes one or any combination of signals effective to be perceived by subjects 1070, including, but not limited to, video, audio, static, and animated content. Device 1010 is of standard design and construction and will be familiar to those having ordinary skill in the art as will be apparent from the disclosure herein. The OOH device further includes at least one interaction sensor 1014, that is configured to detect, and optionally measure or estimate, interactions between the OOH and the target audience. Interaction sensor 1014 includes, but is not limited to, one or more sensors designed to detect and, optionally identify subject actions such as: eye contact, facial expressions, body language, bodily gestures, or vocal or other audible responses. The sensor can include one or any combination of these. In some embodiments, sensor 1014 includes an array of sensors (not shown) that enable detection of interactions from multiple physical locations. The design, construction, and use of such sensors will be familiar to those having ordinary skill in the art.

Signals are sent to, and received from, OOH 1010 using a computer and signaling network, such as the Internet 1020 or other system for enabling communication among two or more electronic devices. The details of such networks are known to those having ordinary skill in the art. According to one embodiment of the invention, signals from OOH 1010 and other components of the network (described below) are sent and received via a data processing and routing mechanism 1030, described more fully hereinbelow, which is configured to process and exchange data with the OOH and one or more display controller devices (1040 and 1050) that are configured to accept data from the OOH and the input mechanism and control the content displayed on OOH device 1010. In some embodiments, data processing and routing mechanism 1030 is also configured to control the content of OOH device 1010. In some embodiments, the display controller devices are client interfaces configured to access stored data, e.g., on a central data repository 1060, and managed by processing and routing mechanism 1030. Such client devices may reside, for example, on computers located at one or more advertisers displaying marketing content on OOH display 1010 and collecting information from sensor 1014.

In some embodiments system 1000 further includes an input mechanism to enable subjects (shown generally at 1070) to provide responses to, and optionally influence or control, content displayed on OOH 1010. Such responses include the above-enumerated actions in addition to direct input from electronic devices, such as wireless phones 1080, as well as personal digital assistants (not shown), portable or stationary computers (not shown), or any other suitable device. In some more specific embodiments, the input mechanism is a a mobile device. In still more particular embodiments, the mobile device is a cellular phone or a personal digital assistant. In those embodiments for which the input mechanism is the latter, signals are sent from the device 1080 to a receiver 1085 and transmitted across the above-described network to data processing and routing mechanism 1030, which relays the raw or processed signal, or data derived from the raw or processed signal, or any combination thereof, to one or more display controller devices. The provision of the devices for enabling input can be accomplished by those having ordinary skill in the art.

In operation, subjects 1070 view or otherwise perceive the content provided on OOH display 1010 provided by one or more display controller devices via the data processing and routing mechanism, or directly from the data processing and routing mechanism. Responses to the content are detected by detector 1014 and relayed back to display controller devices via the data processing and routing mechanism, or directly to the data processing and routing mechanism, for review, analysis, storage, or some combination thereof. In some embodiments, one or more subjects e.g., subject 1072, is incorporated into the content displayed by OOH display 1010, e.g., as a projection 1072′. Responses received from the subjects, e.g., using a cell phone 1080 over wireless network 1085, are received by data processing and routing mechanism 1030. The data processing and routing mechanism may process exchange the received response data with the OOH or one or more display controller devices (1040 and 1050), or some combination thereof, to control the content displayed on OOH. For example, a subject may instruct OOH display 1010 to display image 1072′ upside down or transform, e.g, “morph”, image 1072′ into a space alien form.

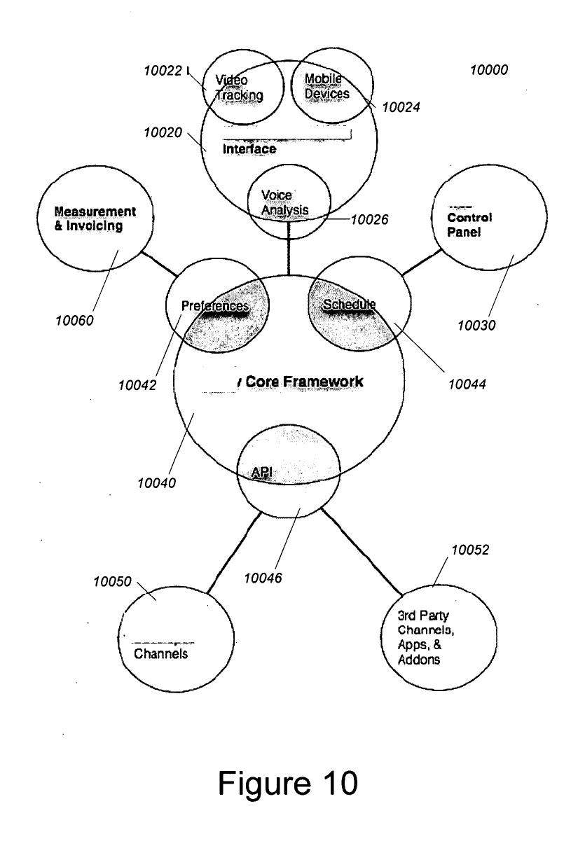

Illustrations of certain devices and the operation of some of the elements of FIG. 1 are provided below with additional reference to FIG. 10, using the IMCTV product (available commercially from Studio IMC of New York, N.Y.) as an example. However, equivalent devices will be apparent to those having ordinary skill in the art.

One example of a system in accordance with the present invention is shown at 10000 in FIG. 10. In one embodiment, a first component of the system of the invention is an interface 10020, which, in some embodiments, comprises a video tracking function 10022, a mobile device interaction function (e.g., cell phone interface) 10024, and a voice control function 10026, and, optionally, one or more other HCIs (Human-Computer-Interfaces, not shown) that enable subjects to interact with content provided by the OOH, including, but not limited to, experiencing the content, controlling the content, browsing the content, subscribing to the content, and downloading the content. In some embodiments, the content is so sensually rich as to be “immersive”. Providing such components and functions will be familiar to those having ordinary skill in the art.

A second system component is the “Control panel” 10030, which, in some embodiments, is a Web-based portal where system administrators can schedule content, alternate between videos, and interactive games, promotions, and other entertainment types. This portal allows administrators to control scheduling across entire network of installations, a region, or a single display. Providing such components and functions will be familiar to those having ordinary skill in the art.

A third and central component of the a “Core Framework” 10040, which in some embodiments comprises a scheduling system 10042, user-configurable preferences 10044 controlling elements such as data feeds and types of interaction, and various application programming interfaces (APIs) 10046. In more specific embodiments, the Core Framework APIs are configured to enable system administrators to customize interactive content using “channels” 10050 while also encouraging third-party developers to create their own open-source channels and other software applications 10052. Providing such components and functions will be familiar to those having ordinary skill in the art.

A fourth system component is a “Measurement and Invoicing” function 10060, which, in one embodiment, is a combination of data analytics, measurement reporting, and invoicing based on the measurement data received from each POP display. In more specific embodiments, the Measurement and Invoicing function records information about a viewer's interaction with a display and uses this information to generate one or more reports that enable a marketer to estimate a return on the display. In still more specific embodiments, billing is made on a “Pay-Per-Interaction” basis using such reports. For example, and without limitation, upon detecting that the a person is interacting with a display, the system will record a single “interaction” as well as analyzing other factors such as the length time a viewer spends looking at the display, the intensity of the interaction, and other various characteristics of the interaction. Upon analyzing this user data the system can initiate a report that will include the data and bill clients accordingly. Providing such components and functions will be familiar to those having ordinary skill in the art.

### 4.2

### 4.3 Recording Interaction with Displays Using the Interface and Core Framework

In another aspect, the above-described system is configured to provide provide, among other things, reports of subject interaction with a display—POP- or OOH-based—on a subject's interaction(s) with a display or upon detecting some other client-defined event. In one embodiment the system is configured to capture the interaction of a subject non-intrusively. If the Interface detects the subject beginning to interact with content on the display, the Interface notifies the Measurement and Invoicing application of the occurrence of such an event, and the subject's interaction is recorded and posted on a server for viewing. Providing such components and functions will be familiar to those having ordinary skill in the art.

In another embodiment, the Reporting and Invoicing application records data about the subject's interaction with a display. In such an embodiment, for example, the data is recorded during a period of time, and the Reporting and Invoicing application selects or marks portions of the recorded data so that the data corresponding to the time when the was interacting with the display or a portion thereof can be later easily identified. In an alternative embodiment, the Reporting and Invoicing application modifies the reports, such as add an impression, or perform different functions and analyses based on the subject's attention, intensity of interaction, or other metrics data. The reports could also suggest that the advertising content needs to be modified in one area vs. another. When the Interface detects the subject is stopping interacting, an event indicating that marking of the data being recorded should stop, the gaze tracking unit, mobile device control unit, or voice control unity may notify the Reporting and Invoicing application to stop marking the data that is being recorded. In still another alternative embodiment, the Reporting and Invoicing application starts recording data upon detecting that a subject is interacting with the display, or a portion thereof, and the event of the subject stopping interacting with the display is interpreted as a request to stop recording. Providing such components and functions will be familiar to those having ordinary skill in the art.

In yet another embodiment, the Reporting and Invoicing application prepares a report in Web or mobile formats displaying events that happened during the time period when the subject was interacting with the display, and may provide the report to an administrator. In more specific embodiments, the report includes a series of snapshots of textual and graphical displays, or it includes all recorded data that can be later used by an administrator. In other embodiments, the report highlights certain elements of the subject interaction with the display such as the intensity, length, number of people, height of people and other subject-oriented metrics. In still other embodiments, the report provides a “weather map”-style fast-forward display of what happened during the time subjects interacted with the displays. Those having ordinary skill in the art will understand that different report formats can be prepared based on the subject interaction statistics or other metrics such as demographic information. Providing such components and functions will be familiar to those having ordinary skill in the art.

In an alternative embodiment, in addition to preparing a report the Reporting and Invoicing application also alerts an administrator at times when a subject is interacting with a display or some portion of the display. In one embodiment, the process of alerting an administrator may include modifying a Web page or sending an email or text message to a mobile device. For example, the Reporting and Invoicing application could modify the Web page by tallying the number of interactions. However, it should be understood that different modifications could be applied to the website or mobile alert as well. Further, alternatively, the alerts could be about the timing of the impressions and the number of concurrent impressions. In such an embodiment, the data could be based on how long the subject is interacting with one or more displays and how many subjects are interacting with one or more displays at any given moment. Alternatively, alerts could only be provided to an administrator upon detecting a condition triggering generation of an alert. It should be understood that such conditions could be administrator configurable. Providing such components and functions will be familiar to those having ordinary skill in the art.

4.4 Hardware and Software for Providing Control of OOHs

The various embodiments of the invention can be operated in an entirely software embodiment, in an entirely hardware embodiment, or in a combination thereof. However, for sake of illustration, the embodiments are described in a software-based embodiment, which is executed on a computer device. As such, the embodiments take the form of a computer program product that is stored on a computer readable storage medium and is executed by a suitable instruction system in the computer device. Any suitable computer readable medium may be utilized including hard disks, CD-ROMs, optical storage devices, or magnetic storage devices, for example. The components just recited, their functions, and their configuration will be familiar to those having ordinary skill in the art.

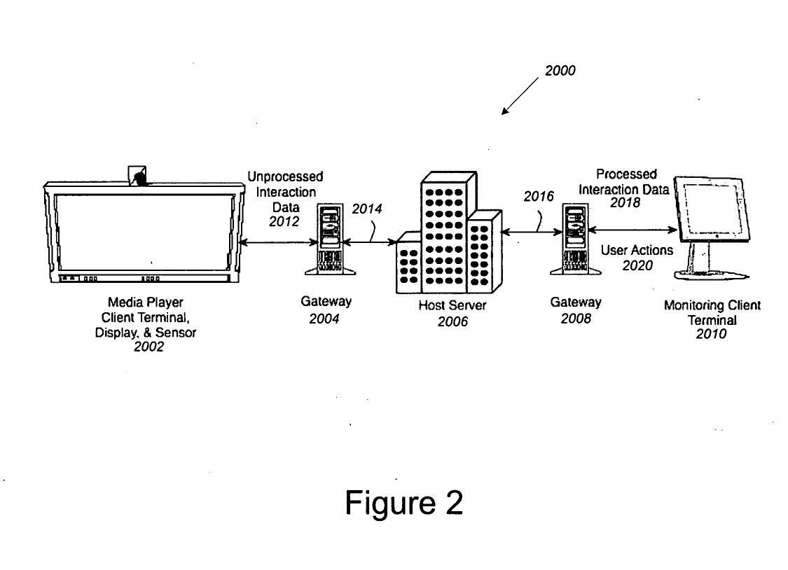

Referring to FIG. 2, an example communication that might occur between a server, a media player client, and a monitoring client terminal in accordance with the present invention is shown at 2000. During an advertising campaign, unprocessed content scheduling data and user interaction data 2012, in the form of messages, is relayed from a media player client 2002 over communication links 2014 to a data processing and routing mechanism 2006 (e.g., data processing and routing mechanism 1030 of FIG. 1). Then processed scheduling data and interaction data 2018, in the form of messages, is relayed from the host server over communication links 2016 to a monitoring client terminal generally indicated as 2010. As illustrated in FIG. 2, intermediate devices, such as gateway(s) 2004 and 2008, may be used to facilitate communications between the client terminals 2002 and the host server 2006. It should be understood that while FIG. 2 illustrates the media player client terminal 2002 and monitoring client terminal 2010 (e.g., display controller device 1040 or 1050 of FIG. 1) communicating with a single host server, in an alternative embodiment, the media player client terminal 2002 could establish connections to more than one host server. Also multiple data processing and routing mechanisms and multiple monitoring clients could establish connections to more than one media player client. Further, in another embodiment, the media player client could also be an even simpler device such as a small microprocessor. The components just recited, their functions, and their configuration will be familiar to those having ordinary skill in the art. The components just recited, their functions, and their configuration will be familiar to those having ordinary skill in the art.

The unprocessed scheduling and interaction data 2012 contains information that characterizes the current state and relative success of an advertisement including, among other parameters, the total number of interactions with the display, the amount of time for each interaction, and which interactive content should play at a given time.

In some embodiments, in addition to managing content scheduling and providing information about interactions, media player clients offer different types of information such as intensity of interaction with an advertisement, types of motion gesture, demographic data, poll data, cell phone numbers, carriers, and even emotional responses based on audio analysis. It should be understood that interaction information provided from an advertisement could include more or fewer items depending on the type of advertisement or the type of advertising campaign. Also, it should be understood that the messages provided in the unprocessed data 2012 may vary in size depending on the content carried by them, and the software at the receiving end may be programmed to understand the messages and to act out certain operations. Also, advertisements are only one embodiment of what can be tracked. In other embodiments, the invention could track subject impressions of paintings in a museum or signs in different parts of a sports stadium. The components just recited, their functions, and their configuration will be familiar to those having ordinary skill in the art.

An administrator may view the processed impression data 2018 provided from media player client 2002 and data processing and routing mechanism 2006 on a monitoring client terminal 2010 using software running on both the data processing and routing mechanism 2006 and the monitoring client terminal 2010. Upon viewing the impression information or a portion thereof, an administrator may wish to take actions, such as invoice clients based on the number of impressions, for example. To do so, the administrator may generate a report on the monitoring client terminal 2010. Upon receiving one or more commands or signals from the administrator, the client terminal 2010 may generate an invoice that reflects the actions taken and the impression data, generally shown on the monitoring client terminal 2010 but also able to convert the invoice to email and other formats. These invoices can also be created manually by the system administrator using the metrics data recorded. It should be understood that different types of messages or order types can be submitted to the data processing and routing mechanism 2006, all of which may be considered various types of transaction information. Once generated, user action messages 2020 may be sent from the monitoring client terminal 2010 to the data processing and routing mechanism 2006 over communication links 2016. The components just recited, their functions, and their configuration will be familiar to those having ordinary skill in the art.

4.5 System Function and Operation

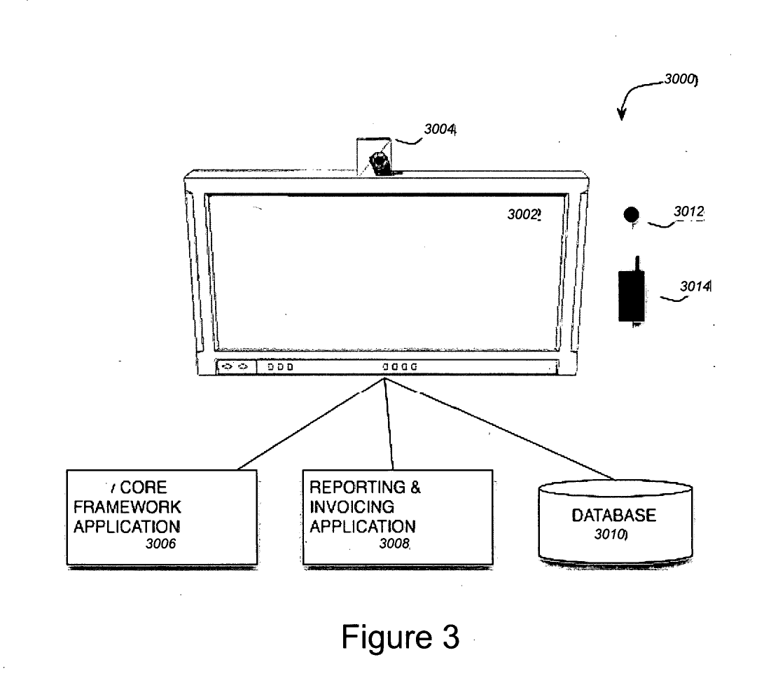

FIG. 3 is a block diagram illustrating an exemplary system 3000 for management of interactive content and interaction data from displays using gaze tracking inputs according to one example embodiment. The system 3000 includes a display unit or screen(s) 3002, camera associated with video tracking unit 3004, voice analysis unit (microphone) 3012, and cell phone control 3014 for following and tracking positions and movements of a subject's body, head, and eyes as well as the verbal remarks and cell phone interactions of users. According to one embodiment, the video tracking interface 3004 may capture the subject's movement, and then provide the subject's motion duration data to the Core Framework 3006 and the Reporting and Invoicing application 3008. FIG. 3 illustrates the display having a video tracking interface, mobile device control, and voice control. However, in an alternative embodiment, the system 3000 includes multiple interfaces to monitor a subject's interaction in relation to a plurality of displays. Also, it should be understood that the embodiments described herein are not limited to any number of displays or interfaces, and fewer or more displays and tracking interfaces could also be used. In addition, different types of motion detection can be used besides video tracking. Other types of tracking could include, but are not limited to, infrared, ultrasonic, or any other sensing technology. The components just recited, their functions, and their configuration will be familiar to those having ordinary skill in the art.

In one embodiments, upon receiving the subject's interaction data, Core Framework 3006 determines the subject's interaction characteristic in relation to the display and signals the Reporting and Invoicing application 3008 so that, in one embodiment, the Reporting and Invoicing application 3008 starts preparing a report of events occurring while the subject is looking at the display. It should be understood that the report may take many different formats, and may include textual and graphical data. Also, in one embodiment, an administrator may specify a number of rules defining how the interactions should be recorded, filtered, and formatted. For example, if a monitoring client terminal displays a report data, an administrator may wish to configure a number of rules that will cause the Reporting and Invoicing application 3008 to only record certain types of impression data such as the total number of interactions, while not recording any data about the duration of the interactions or other metrics. In one embodiment, the Reporting and Invoicing application 3008 continues preparing the report until the Core Foundation application 3006 sends a stop signal to the Reporting and Invoicing application 3008. For example, the Core Framework 3006 generates the stop signal upon detecting that the subject has stopped interacting with the display; the Reporting and Invoicing application 3008 then provides the generated report to an administrator. It should be understood that the report could be displayed to an administrator immediately upon detecting the subject stopping interacting with the display for which the report was created. Alternatively, an administrator may control when he (or she) views the report. In some embodiments, an administrator defines rules to be used by the Reporting and Invoicing application 3008 to prioritize which of the recorded data should be shown first. In such an embodiment, the Reporting and Invoicing application 3008 processes data from many displays, and reports the highest priority items first. In other embodiments, the Reporting and Invoicing application 3008 save its reports in a database 3010. The components just recited, their functions, and their configuration will be familiar to those having ordinary skill in the art.

In the system 3000 illustrated in FIG. 3, the Reporting and Invoicing application 3008 is connected to display used for advertising. However, in other embodiments the Reporting and Invoicing application 3008 controls displays connected to more than one media player client. Such displays include, but are not limited to: digital displays, projections, billboards, print ads, POP, end-of-aisle displays, OOH, and any other medium where interactions can be scheduled and measured. In such embodiments the Reporting and Invoicing application 3008 may communicate over a network with the displays associated with other media player clients, and can mediate the reporting process over one or more networks. Also, while FIG. 3 and subsequent figures refer to using interaction and scheduling related data, the embodiments are not limited to scheduling interactive content and monitoring how many subjects interact. Alternatively, the Reporting and Invoicing application 3008 can perform its functions in response to other user attention based inputs. For example, the Reporting and Invoicing application 3008 could manage the reports according to the embodiments described below when it detects that multiple people are interacting with a display and when people are laughing, smiling, or jumping up and down. However, it should be understood that still other events can be considered interaction data. The components just recited, their functions, and their configuration will be familiar to those having ordinary skill in the art.

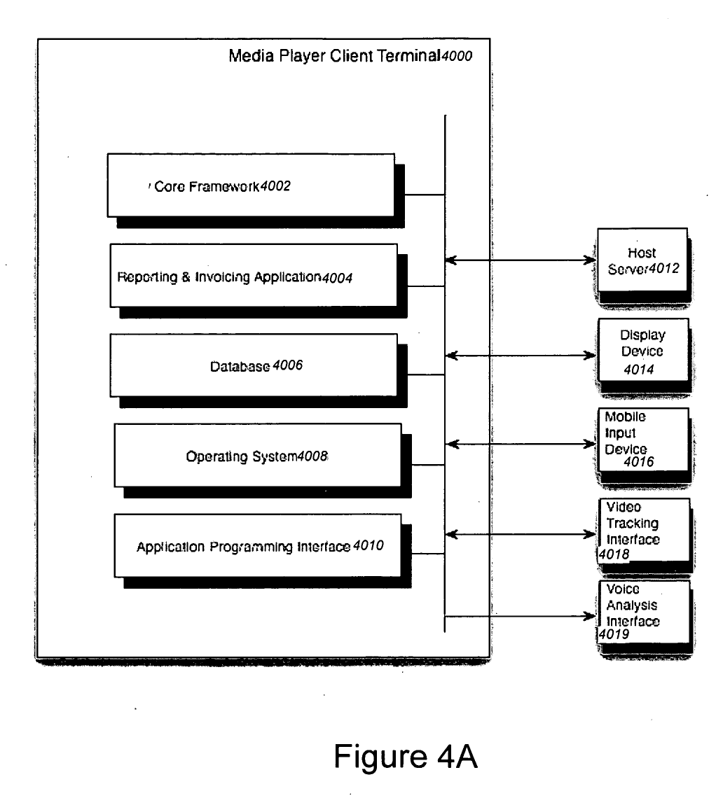

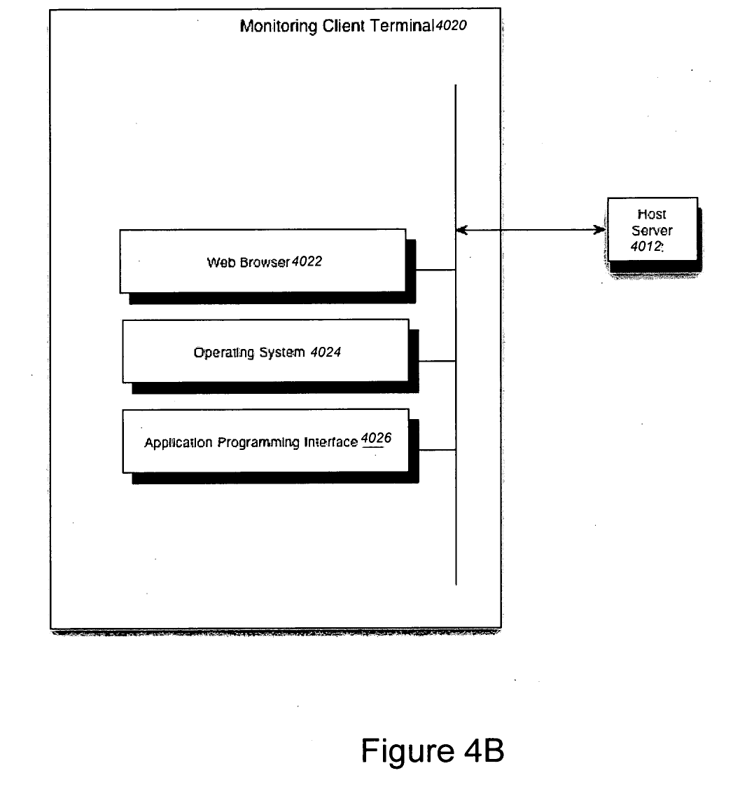

FIG. 4A is a block diagram illustrating a media player client terminal 4000 with a number of layers defining different functions that are used to implement operation in accordance with the various embodiments of the present invention. In one embodiments, the layers include Core Framework 4002, a Reporting and Invoicing application 4004, a database 4006, an operating system 4008, and an application programming interface (“API”) 4010. In some embodiments, the client device 4000 includes, among other things, at least a processor and a memory unit. The components just recited, their functions, and their configuration will be familiar to those having ordinary skill in the art.

In one embodiment, the Core Framework 4002 and the report generating application 4004 store impression information on one or more host servers 4012 (i.e., data processing and routing mechanisms, such as shown at 1030 in FIG. 1 and at 2006 in FIG. 2) through an interface, such as the API 4010. A commercially available media player client that allows an administrator to schedule digital content on displays is Webpavement of Atlanta, Ga. Webpavement also provides an electronic content scheduling interface, referred to as Sign Admin, in which the number of advertising monitors are displayed in association with which content is being shown. However, the embodiments are not limited to any particular product that performs translation, storage, and display reporting based on subject interaction and scheduling of interactive content. Relevant aspects of Webpavement Sign Server and Sign Admin are described in U.S. patent application Ser. No. 09/818,020, entitled “System for Facilitating Digital Advertising,” filed on 26 Mar. 2001, the contents of which is incorporated herein by reference in its entirety and for all purposes. The components just recited, their functions, and their configuration will be familiar to those having ordinary skill in the art.

In one embodiment, when the Core Framework 4002 receives subject interaction data from a video tracking interface 4018, mobile device input 4016, and voice analysis interface 4020 the Core Framework 4002 determines the number of subject's gazes in relation to one or more displays, including digital displays, print ads, or any other visual medium. Upon detecting that the subject has shifted his eyes toward one of the displays, the Core Framework 4002 signals the Reporting and Invoicing application 4004 to start generating a report about the display. The Reporting and Invoicing application 4004 may start recording impression data or any other data while the user is looking at the display. Also, in one embodiment, the process of updating the reports preferably resumes immediately upon detecting the subject stopping interacting with the display. In fact, the Reporting and Invoicing application 4004 could stop generating the report as soon as the video tracking interface 4018, mobile device input 4016, and voice analysis interface 4019 detects that there is a reasonable probability of the interaction stopping with the display.

In some embodiments data recorded by the Reporting and Invoicing application 4004 is saved in the database 4006. The database 4006 may be any data storage entity that provides writing and reading access. In one embodiment, the database 4006 records any data for the Reporting and Invoicing application 4004, e.g., directly to a memory unit or to some other storage device, such as a computer's hard disk. The display devices 4014 could be CRT-based video displays, projections, LCD-based displays, immersive environments, LED billboards, gas plasma-panel displays, displays that show three-dimensional images, different display types, or the combination thereof. The input devices 4016, 4018, and 4020 may also include a mouse, a keyboard, touchpad, stylus or a touch-screen display device. However, different input devices such as RFID could also be used. The components just recited, their functions, and their configuration will be familiar to those having ordinary skill in the art.

The operating system 4008 manages hardware and software resources of the media player client terminal 4000. General functions of the operating system 4008 may include processor management, memory management, device management, storage management, application interface, and user interface. Any type of the operating system 4008 may be used to implement the present embodiments, and examples of common operating systems include the Microsoft WINDOWS family of operating systems, the UNIX family of operating systems, or the MACINTOSH OS X operating systems. However, those ordinarily skilled in the art will recognize that the added complexity of an operating system may not be necessary to perform the functions described herein. The components just recited, their functions, and their configuration will be familiar to those having ordinary skill in the art.

FIG. 4B is a block diagram illustrating a monitoring client device 4020 (e.g., one of devices 1040 or 1050 in FIG. 1) with a number of layers defining different stages that may be used to implement embodiments of the present invention. The layers include a web browser or standalone application 4022, a operating system 4024, and an application programming interface (“API”) 4026. The monitoring client device 4020 also preferably includes, among other things, at least a processor and a memory unit (both of which are not shown in the figure, but are well known computer components). Preferably, the processor has enough processing power to handle and process various types of gaze information displayed on a Web page or within the standalone application. Also, it should be understood that memory may include any computer readable medium. The components just recited, their functions, and their configuration will be familiar to those having ordinary skill in the art.

In one embodiment the web browser or standalone application 4022 has access to impression information from one or more host servers 4012 through an interface, such as the API 4026. When the web browser or standalone application 4022 receives subject interaction data from a host server 4012, the Web browser 4022 determines the number of subject interactions in relation to the display and relay this information to a system administrator. In some embodiments, any data displayed by the Web browser or standalone application 4022 is used to invoice advertisers. The invoice may include a physical or digital request for payment based on the impression data. However, different invoice formats such as cell phones text messages, multimedia messages and other electronic transmissions could also be used. Also, the process of converting the impression data to an invoice can be an automated process or a manual process done by the administrator. The components just recited, their functions, and their configuration will be familiar to those having ordinary skill in the art.

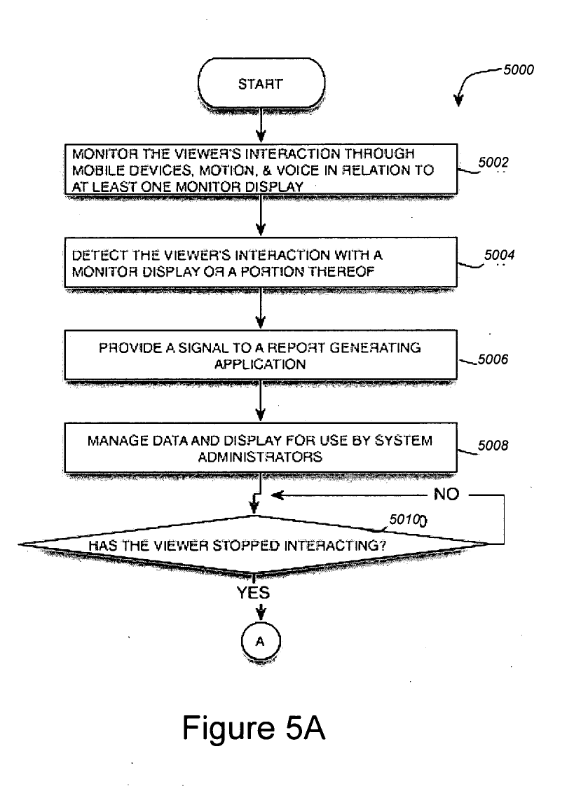

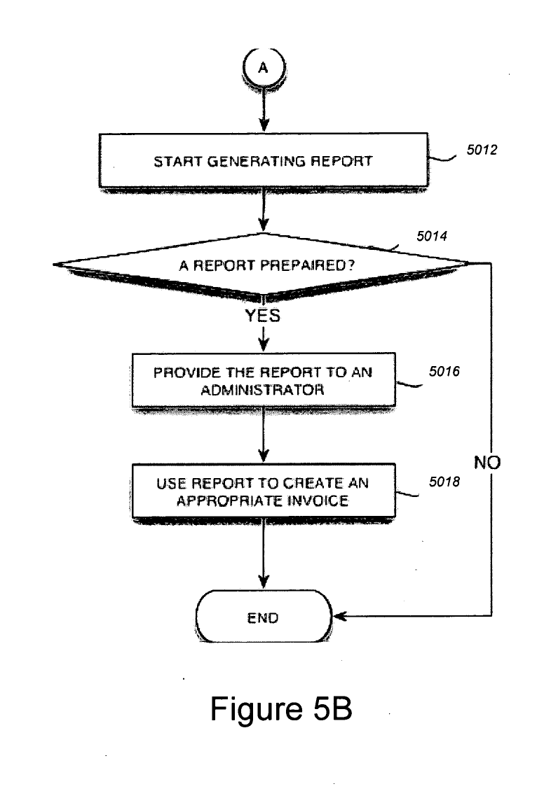

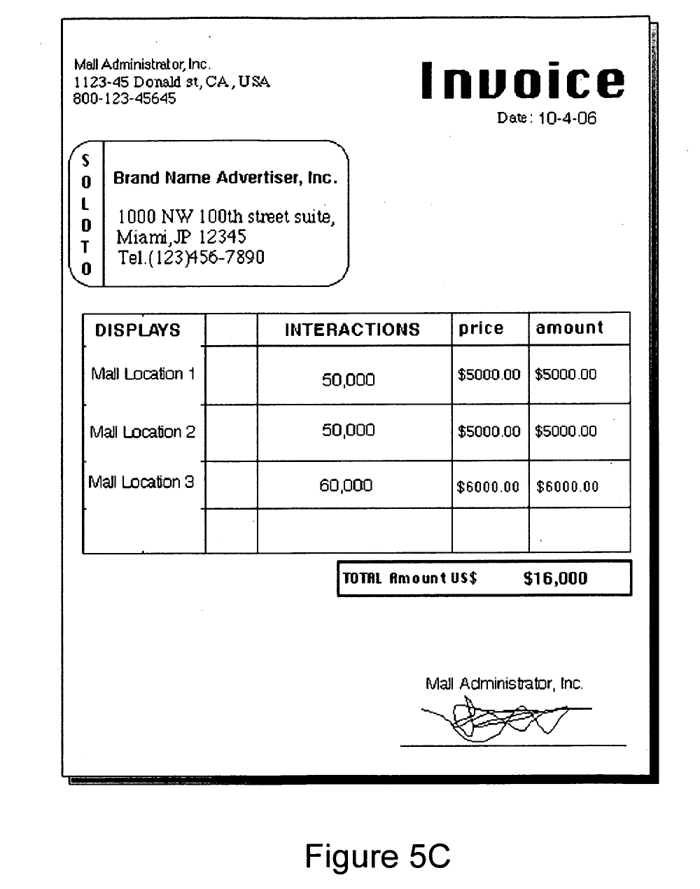

FIGS. 5A and 5B are flow charts illustrating a method 5000 for operation and function of the Interface application which detects the subject's interaction with a display, e.g., through motion, cell phone, voice or other means. The flow diagrams in FIGS. 5A and 5B are described in relation to the elements of FIGS. 4A and 4B. However, it should be understood that more, fewer, or different components could also be used to execute the method 5000.

Referring to FIG. 5A, at 5002, the Core Framework 5002 uses inputs that are provided by the video tracking interface 4018, mobile device input 4016, and voice analysis interface 4019 to determine and display data about the subject interaction in relation to at least one display. In one embodiment, the Core Framework 4002 uses video tracking data to determine the motion characteristics of a subject, such as direction and speed of movement in relation to one of the displays. At 5004, the Core Framework 4002 detects the subject stopping the interaction with at least one display. In an alternative embodiment, Core Framework 4002 is configured to detect a subject's interaction with one or more ads or other interactive content being displayed on a display. In still other embodiments, events other than a subject's interaction with the screen or a portion thereof are detected as well, and one or more of these events trigger the steps of the method described below. The components just recited, their functions, and their configuration will be familiar to those having ordinary skill in the art.

At 5006 the Core Framework 4002 provides a signal to the Reporting and Invoicing application 4004. In one embodiment, the signal includes an identifier defining a display. It should be understood that the administrator could define which of the display should be monitored by the Core Framework 4002 so that the Core Framework 4002 provides a signal to the Reporting and Invoicing application 4006 only when it detects the subject interacting with the displays.

At step 5008, the Reporting and Invoicing application 4004 starts management and display of impression data. In one embodiment, the Reporting and Invoicing application 4004 prepares a report by recording impression data while the subject interacts with the display. For example, the system may be configured to record data during the entire marketing campaign. In one such embodiment, the Reporting and Invoicing application 4004 records the time when the subject interacts with the display or a portion thereof so that it can later go back to the recording and identify the start of the relevant data. It should be understood that various methods can be used to identify where the relevant data has started. In an alternative embodiment, the Reporting and Invoicing application 4004 starts recording the interaction data at the time when the Core Framework 4002 detects the subject interacting with the display or a portion thereof. The components just recited, their functions, and their configuration will be familiar to those having ordinary skill in the art.

In one embodiment, the Reporting and Invoicing application 4004 initiates a process of alerting an administrator upon detecting that the subject interacting with the display or to one or more advertisements being displayed on the display. For example, the Reporting and Invoicing application 4004 could enhance, enlarge, or change colors of all or some advertisements or reports not being viewed by the subject. In another embodiment, the Reporting and Invoicing application 4004 reorganizes the ads and other content being displayed on the display, or obscures some or all ads not being viewed by a subject with some other content. The process of alerting an administrator includes providing e-mail alerts, mobile device alerts, and other types of alerts. In such an embodiments, the message content or the type of the alert used may depend on data not being viewed by a subject at the display or portions of the display. Also, it should be understood that the process of alerting an administrator may be initiated at the time when the subject is interacting with the display or the ad, or at some other time, such as upon detecting an alert triggering condition along with the subject's attention being toward a display or an advertisement. The components just recited, their functions, and their configuration will be familiar to those having ordinary skill in the art.

At step 5010 if the subject's gaze is diverted from the display or from one or more ads being displayed on the display the flow control moves to 5012 of FIG. 5B. At 5012 the Reporting and Invoicing application 4004 discontinues data management for the display. For example, the Reporting and Invoicing application 4004 records the time when the event happened, so that it can later identify the end of the relevant data from the recorded data. In an alternative embodiment, where the Reporting and Invoicing application 4004 only starts recording data upon detecting a user attention based event, the Reporting and Invoicing application 4004 may stop recording upon detecting the subject stopping interacting with the display. Further, alternatively, the Reporting and Invoicing application 4004 could discontinue generating alerts for an administrator in relation to ads or the display being currently viewed by the subject, or may stop modifying the display of the advertisements. The components just recited, their functions, and their configuration will be familiar to those having ordinary skill in the art.

At step 5014, the Reporting and Invoicing application 4004 determines if a report was prepared for an administrator. In one embodiment, the report at least a portion of the data recorded during the time interval when the subject was interacting with the display, or toward one or more advertisements on the display. The report may take many different formats. For example, the report can be a series of textual graphical displays (or both) of what happened during the subject's interaction with the display. Alternatively, the report can include a series of screen or window snapshots, or video data highlighting certain elements on the displays, during the subject's interaction with the display. In some embodiments, an administrator controls which of the displayed data is recorded, or the events that trigger the process of recording data. It should be understood that any combination of report types could be used, or yet some other report type could also be generated. The components just recited, their functions, and their configuration will be familiar to those having ordinary skill in the art.

If the report has been generated, at step 5016, the Reporting and Invoicing application 4004 provides the report to an administrator through the host server (e.g., data processing and routing mechanism 1030 of FIG. 1) and a monitoring client device (e.g., device 1040 or 1050 of FIG. 1). In one embodiment, the Reporting and Invoicing application 4004 provides the administrator a fast-forward style of display of the events that happened during the impression times, so that the administrator can control how quickly he reviews the data in the report. However, it is possible that the subject interaction may quickly shift to another display while the administrator is viewing the report, only to shift back again to the original or yet another display. In such an embodiment, the Reporting and Invoicing application 4004 may note that there has not been sufficient time to report to the user all actions that occurred during the time interval when the subject's interaction was away from the display or one or more windows on the display, and may keep that information stored for later reporting. Optionally, the Reporting and Invoicing application 4004 can require an acknowledgment of the reported information, such as by an action the subject may take with an input device, or by detecting that the administrator had a sufficient time to view the reported items. Alternatively, rather than waiting for the subject's interaction with the display, the administrator may opt to view the generated report via another device while the subject is away from the location of the displays. As an example, the administrator could view the report via a wireless device that is capable of receiving and displaying to the user snapshots of information being received from the Reporting and Invoicing application 4004. The components just recited, their functions, and their configuration will be familiar to those having ordinary skill in the art.

In another embodiment, the Reporting and Invoicing application 4004 operates in conjunction with another display data application. In such an embodiment, the Reporting and Invoicing application 4004 may notify the display data application of the event that the recording should begin, such as upon detecting a subject's interaction with a display or a portion thereof, as in the embodiment described in reference to FIGS. 5A and 5B, or upon detecting some other event, such as a subject interaction through gesture or cell phone. Later, the Reporting and Invoicing application 4004 could notify the display data application of another event indicating that the display data application should preferably stop recording. Then, the Reporting and Invoicing application 4004 could provide another signal upon detecting the occurrence of an event that a report should be prepared and provided to an administrator. However, it should be understood that still different embodiments could be possible as well. The components just recited, their functions, and their configuration will be familiar to those having ordinary skill in the art.

While the above embodiments described the Reporting and Invoicing application 4004 preparing a report or modifying the display while the subject interacts with the display, different embodiments are possible as well. For example, the Reporting and Invoicing application 4004 managing a display that is not being attended by an administrator may encounter an event of such a high priority that it might notify the administrator right away. In one embodiment, because the Reporting and Invoicing application 4004 continuously receives subject interaction data from the Core Framework 4002, it may at any time determine the current type of interaction based on the received data. Knowing the current type of interaction, the Reporting and Invoicing application 4004 may send notifications of appropriate severity to administrators. Also, the process of alerting an administrator could include providing email alerts, mobile device alerts, and other types of alerts. In such an embodiment, the message content or the type of the alert used may depend on the appropriate severity.

In some embodiments, in addition to monitoring the subject's interaction, the Core Framework 4002 uses other events as triggers to start managing displayed data according to the embodiments. For example, the events may include an action of minimizing one or more advertisements. In an embodiment where the Reporting and Invoicing application 4004 prepares a report, the Reporting and Invoicing application 304 may consider the event of restoring the advertisement becoming again visible on the screen. Upon detecting either of the events above, the Reporting and Invoicing application 4004 may provide a report to the administrator, and the report may include significant events that occurred since the last time the subject interacted with the ad, or otherwise summarize the activity that has taken place when the ad was minimized or replaced by another ad.

In further alternative embodiment, administrators uses the system and methods described above to invoice advertisers based on the number of interactions recorded in the reports. For example, a Reporting and Invoicing application running on a computer of an advertising campaign administrator may be configured to receive information from report generating applications of the individual displays, and may alert the administrator when one or more pre-configured alert conditions are detected based on the received data from the display. In such an embodiment, the administrator could view summary reports describing each subject's activities, snapshots of displays corresponding the subject's displays, or even full videos of actual subjects during a specific time frame, along with information defining how the subjects interacted during that time. However, it should be understood that different embodiments are possible as well. This report data can then be used by the administrator to bill the advertiser based on the number of impressions, the average length of each interaction, or any other metrics gathered. The metrics data can be converted to an invoice automatically or manually by the system administrator. The components just recited, their functions, and their configuration will be familiar to those having ordinary skill in the art.

At step 5018 the report given to the administrator can also be used to create an appropriate invoice. For example, using the data about subject interaction with displays, an invoice can be automatically created and even sent to a client. In an alternative embodiment, as shown in step 5020, the report data can used by a system administrator separately from the system software processes to manually invoice the client based on the metrics and report data. The components just recited, their functions, and their configuration will be familiar to those having ordinary skill in the art.

FIG. 5C is a representation of a possible implementation of the invoice that would be generated based on the report data in one embodiment of the present invention. The invoice of FIG. 5C includes, for each administrator and buyer, a list of displays with a corresponding number of interactions and the monetary amount being charged for the interactions. In one embodiment, the administrator may be a mall owner and the buyer may be a brand-name advertiser. In another embodiment, the administrator may be a retail store and the buyer may be a market ratings firm like Nielsen. Any two parties may be the buyer and seller. And displays can be anything from digital screens to print posters. Also, interactions can be replaced or complemented by any type of data or metrics stored in the report provided to the administrator. In one embodiment, the impressions could be replaced by the average length of an interaction, and intensity of interaction with a corresponding amount invoiced. In another embodiment, both the number of interactions and the average length of those interactions could be used to decide how much to charge. An example would be to charge $1 for every interaction plus an additional amount for every location with an average interaction time of over five seconds. However, any data in the administrator report can be used to determine what amount will be invoiced. The components just recited, their functions, and their configuration will be familiar to those having ordinary skill in the art.

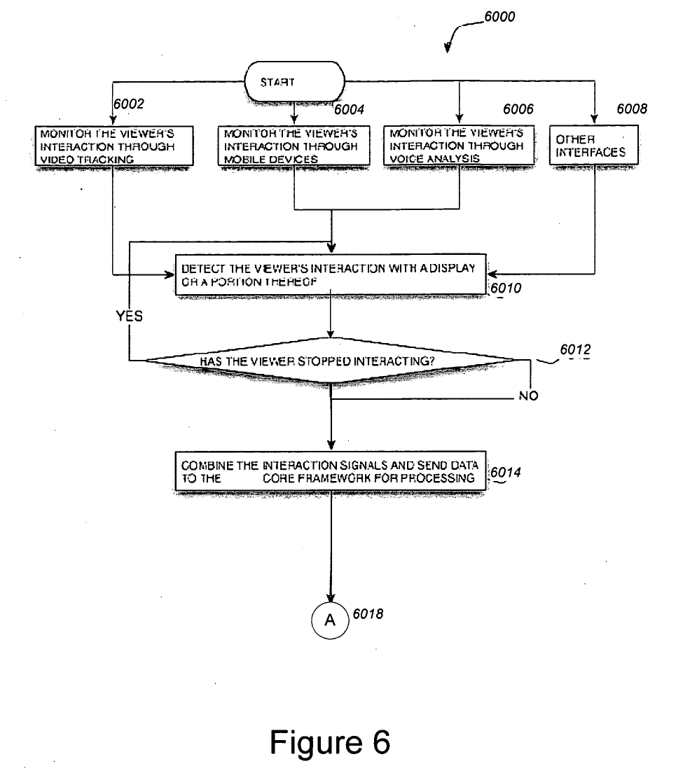

FIG. 6 is a flow chart illustrating a method 6000 for the operation and function of the determination of unique “engagements” or “interactions” between a subject and a display. The flow diagrams 6000 will be described in relation to the elements of the media player client terminal in FIGS. 4A and 4B. However, it should be understood that more, fewer, or different components could also be used to execute the software processes and business methods described herein.

Once the interaction data is received, video tracking data 6002, mobile device data 6004, voice data 6006, and other interface data 6008 are processed in the loop shown at 6010 and 6012 After detecting the subject interaction 6010, the interaction signals are analyzed, combined, and sent to the Core Framework (at 6014) to be used for controlling the interactive content. In one embodiment, a software code structure for this data has the form shown here:

typedef struct Interactor
{
CvPoint interactionCenter; //the center of the possible
interaction coordinates
int ID; //a unique sequential identifier
of possible interactors or people
int foundFrames; // number of people found interacting
int avgTime //average time spent interacting
int interactionIntensity //average intensity of
interaction as measured by speed and other factors
int phoneNumber // phone number
string voteChoice // audience choice during a poll
string interactionType // type of interaction: motion,
mobile device, voice, other
} Interactor;

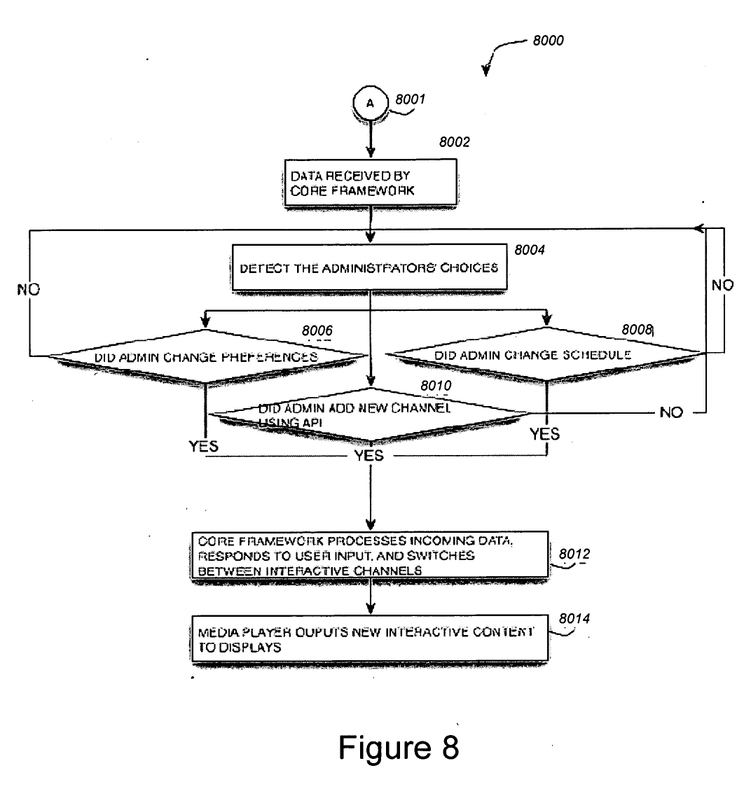

As will apparent to those of ordinary skill in the art, the code includes a center within the image coordinate system, a unique identification number, the number of people interacting, the average time of each interaction, the average intensity of each interaction, the phone number of mobile interactors (subjects), the vote choices of interactors (subjects), and the type of interaction among other possible parameters. These new data structures are then combined and sent to the Core Framework 6014 for further processing. This is just one of many possible structures for the incoming interface data. It should be understood that more, fewer, or different components and different programming languages could also be used to execute the software processes and business methods described herein. At 6018, process then moves to 8000 of FIG. 8 as described below at 8001 of that Figure.

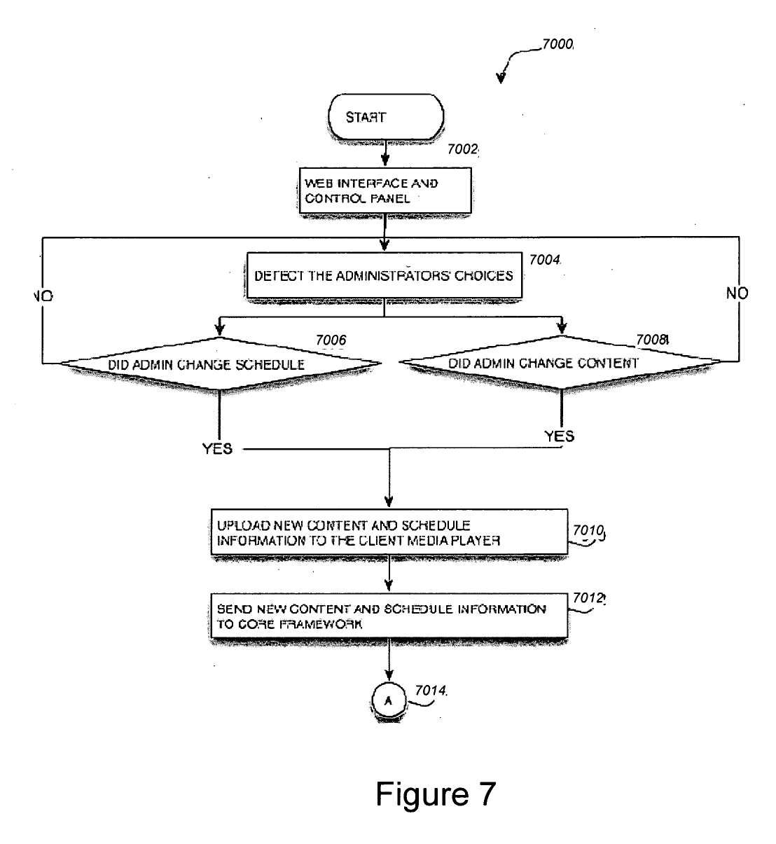

FIG. 7 at 7000 illustrates one embodiment of a system to enable administrators to control the system of the invention through a Web Interface and Control Panel (shown at 7002). Upon detecting the administrators choices 7004 and determining that the system new content or schedule information is available (7006 or 7008 respectively), the new information is provided to the client media player and the Core Framework (7010 and 7012). In one embodiment, the content scheduling and content choices are made through a document of varying formats depending on user requests; although HTML is typical as it can be reported through any number of mechanisms, on-line or off-line, such as permanent or dial-up Internet or modem connection, writing files to removable media such as CD-ROM, or displaying on-screen at any time of user requests or examining them remotely using a standard web-browser or mobile device. The components just recited, their functions, and their configuration will be familiar to those having ordinary skill in the art. At 7014, process then moves to 8000 of FIG. 8 as described below at 8001 of that Figure.

As shown in FIG. 8 at 8000, the Core Framework receives data from other parts of the system 8002 following operations 6018 (FIG. 6) or 7014 (FIG. 7). Upon detecting the administrator's choices 8004, the Core Framework then processes the data, responds to user input, and switches between interactive channels. In one embodiment, this includes actively switching one interactive channel to another for some or all displays. In another embodiment this includes receiving and playing new content to be used in an interactive channel on some or all displays. In another embodiment admin preferences are set to receive only data from certain devices or for certain installations (or both).

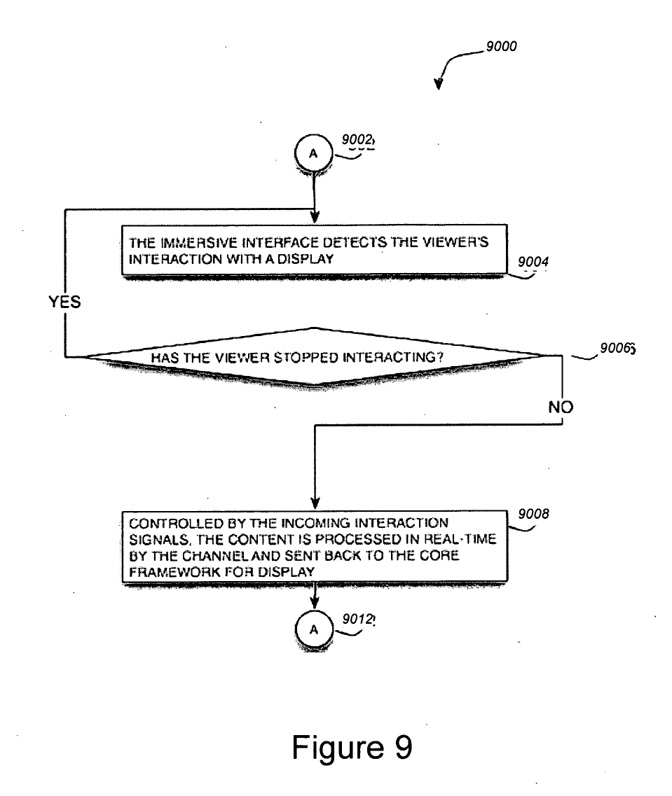

FIG. 9 illustrates a process for detecting a subject's interaction with a display 9000. At 9004 the interaction is detected as described above. If the subject has stopped interacting with the display (9004), then the data is then processed by the specific channel and the resulting content sent back to the Core Framework for display (9008). In one embodiment, this includes actively fast-forwarding through a video based on a user's movements, so if a subject moves right the video moves forward in time and if the subject moves to the left the video moves back in time. In another embodiment the poll results can change due to subject votes coming from mobile devices. In yet another embodiment, digital effects can be added to an image based on the volume of the subject's voice.

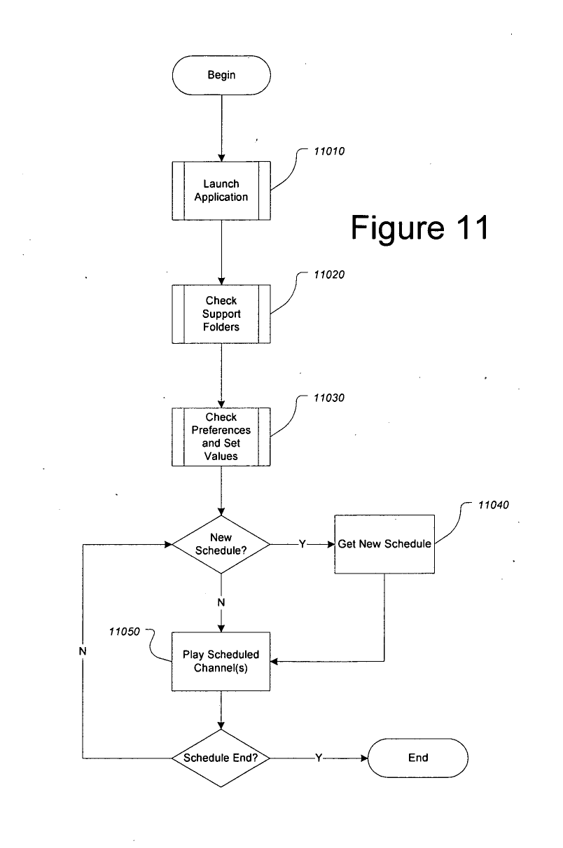

FIG. 11 illustrates one embodiment of a mechanism for controlling OOH display 1010 by data and processing mechanism 1030 (see FIG. 1) at 11000. Those having ordinary skill in the art will understand that the operations described with respect to FIG. 11 can be accomplished using software, hardware, or a combination thereof, using a variety of known techniques beyond those described for exemplary proposes herein. In one embodiment, content is provided to OOH display using “channels”. A “channel”, as defined herein, is an external file which has media content, either procedurally generated (e.g., 3-D graphics drawn in real time, or generated text drawn on screen), or saved or cached media files like photos and video and the like. in one embodiment, channels are scheduled by a scheduling system as described below. In a more particular embodiment, the channels are modular and not hard-coded into the main application, thereby facilitating quick prototyping and deployment. In still more specific embodiments, the channels are configured to download independently data (such as XML feeds) to reflect real-time interaction data from subjects, access video inputs, media files, fonts, network data. In yet more specific embodiments, the channels are configured to interact with one or more back-end servers. For example, subjects can text message a particular phone number or short code in response to an OOH display, which the server then encodes as particular values in an XML file. The channel then downloads that data and displays it (or some derivative thereof) on the OOH to the subjects.

In some embodiments, the channels are scheduled to repeat indefinitely (referred to herein as “relative scheduling”). In other embodiments, the channels are scheduled to run at a specified time (referred to herein as “absolute scheduling”). In one embodiment, schedule files are XML documents which contain the necessary information pertaining to the scheduled channel, its mode (absolute or relative, and any other data the channel may need). In a more particular embodiment, the schedule file is located on a server and downloaded periodically to the individual data and processing mechanism (e.g., and IMCTV installation). In one embodiment, the channel is used to schedule for channel and time (with relative and absolute scheduling) using a display controller device, such as illustrated at 1040 and 1050 in FIG. 1. Those having ordinary skill in the art will appreciate that channels as defined herein are interactive and act like individual programs akin to an operating system program scheduler.

At 11010, the system launches an display control application. In one embodiment this operation includes populating the schedule with any default channels (included in main application bundle); initializing the graphics and display engine (e.g., open GL); and creating a channel renderer and cached channel array For each channel in channel folder a loaded channel is created and added to the cached channel array. The current channel is sent to a default channel, and render timer with render callback function (see 11030 below) is created. Any set preferences are reloaded, including a background launch daemon if so included.

At 11020 the system checks for any installed channels and other media files, and creates any such files if none are available. The graphics subsystem is initialized and caching is made for all appropriate channels to enhance processing speed. At 11030, the system checks any preferences and sets appropriate values. The system also automatically launches background relaunch daemon if necessary, and sets the operating system settings to reduce the chance of any unwanted on-screen displays from other alert boxes or notification systems.

During execution the system periodically checks for a new schedule, in case there are any changes to the scheduling while the application is running, and fetches the new schedule if found (11040). At 11050, the scheduled channel is played. When the channel is finished, the channel the system rechecks the schedule and loads the next scheduled channel or fetches a new schedule. When all schedules are finished, the application returns to the default schedule as described with respect to 11010 above.

### 5 CONCLUSION

Those having ordinary skill in the art will understand the systems, methods, software, and apparatus provided by the present invention will enable marketers to improve their management and assessment of the value of OOH advertising. Still other advantages and uses will be apparent to those of ordinary skill as well.

The above-described embodiments, alternative embodiments, and specific examples, are given by way of illustration and should not be viewed as limiting. Further, many changes and modifications within the scope of the present embodiments may be made without departing from the spirit thereof, and the present invention includes such changes and modifications. While the present invention is described herein with reference to illustrative embodiments for particular applications, it should be understood that the present invention is not limited thereto. Other systems, methods, and advantages of the present embodiments will be or become apparent upon examination of the following drawings and description. It is intended that all such additional systems, methods, features, and advantages be within the scope of the present invention. For example, any of the functions of the components described herein, such as, but not limited to, display controller devices 1040 or 1050 (or both) shown in FIG. 1 and display controller device 1030 shown in FIG. 1 can be implemented in many equivalent hardware or software configurations (or some combination thereof), without the need for the specific connections illustrated. For example some or all of the equivalent functions can be implemented using hardware or software (or a combination thereof) in OOH Device 1010, or as a separate device coupled therewith. Those having ordinary skill in the art will understand that such alternate configurations and embodiments are functionally identical to the invention. Similarly, equivalent configurations of the components described in the exemplary embodiments illustrated in FIGS. 2, 3, and 10 can be implemented in many equivalent arrangements of hardware and software to provide systems, apparatuses, and methods that are equivalent to invention as illustrated herein. Moreover, the functions implemented by the exemplary methods illustrated in FIGS. 5A, 5B, 6-9, and 11 can be implemented in many different ways without departing from the invention.

It will be apparent to those of ordinary skill in the art that methods involved in the system and method for display management using gaze control inputs or any other user attention based inputs may be embodied in a computer program product that includes one or more computer readable media. For example, a computer readable medium can include a readable memory device, such as a hard drive device, a CD-ROM, a DVD-ROM, or a computer diskette, having computer readable program code segments stored thereon. The computer readable medium can also include a communications or transmission medium, such as, a bus or a communication link, either optical, wired or wireless having program code segments carried thereon as digital or analog data signals.

What is claimed:

1. A system for monitoring and managing out-of-home (OOH) displays, comprising:
an OOH display device configured to display content to at least one subject, said OOH display device including an interaction detector, said interaction detector being configured to detect at least one instance of an interaction between said OOH display device and a subject and provide interaction data based at least in part on said detection;
an input mechanism, said input mechanism being configured to accept input signals from a subject;
a display controller device, said display controller device being configured to accept data from said OOH display device and said input device; and
a data processing and routing mechanism, said data processing and routing mechanism being configured to process and exchange data with said OOH display device, said input mechanism, and said display controller device.

2. The system of claim 1, wherein said input mechanism is a mobile device.

3. The system of claim 2, wherein said mobile device is a cellular phone or a personal digital assistant.

4. The system of claim 1, wherein said interaction detector is configured to receive gesture, voice, or gaze interaction information.

5. The system of claim 1, wherein said data processing and routing mechanism is configured to receive data from said OOH display device and said input mechanism, and relay said data to said display controller.

6. The system of claim 5, wherein said data processing and routing mechanism is configured to receive data from said display controller, and relay said data to said OOH display device and said input mechanism.

7. The system of claim 6, wherein said display controller is configured to control said content of said OOH display device.

8. The system of claim 1, wherein said data processing and routing mechanism is configured to receive data from said display controller, and relay said data to said OOH display device and said input mechanism.

9. The system of claim 1, wherein said display controller is configured to control said content of said OOH display device.

10. The system of claim 9, wherein said display controller is configured to control said content of said OOH display device in response to data received from said data processing and routing mechanism.

11. A method for controlling the content of an OOH display device, comprising:
providing a data processing and routing mechanism, said data processing and routing mechanism being configured to process and exchange data with said OOH display device, said input mechanism, and said display controller, wherein said OOH display device is configured to display content to at least one subject, said OOH display device including an interaction detector, said interaction detector being configured to detect at least one instance of an interaction between said OOH display device and a subject and provide interaction data based at least in part on said detection, said input mechanism is configured to accept input signals from a subject, and said display controller device is configured to accept data from said OOH display device and said input device;
receiving data from at least one of said OOH display device, said input mechanism, and said display controller device at said data processing and routing mechanism; and
relaying data to at least one of said OOH display device, said input mechanism, and said display controller device.

12. The method of claim 11, further including processing said data with said processing and routing mechanism.

13. The method of claim 12, further including processing data received at said data processing and routing mechanism from at least one of said OOH display device and said input mechanism, and forwarding said processed data to said display controller device.

14. The method of claim 13, further including forwarding data received at said data processing and routing mechanism from said display controller device to at least one of said OOH display device and said input mechanism.

15. The method of claim 14, further including changing said display content in response to said data.

16. The method of claim 12, further including forwarding data received at said data processing and routing mechanism from said display controller device to at least one of said OOH display device and said input mechanism.

17. The method of claim 16, further including changing said display content in response to said data.

18. A method for providing an interactive OOH display, comprising:
providing a data processing and routing mechanism, said data processing and routing mechanism being configured to process and exchange data with said OOH display device, said input mechanism, and said display controller, wherein said OOH display device is configured to display content to at least one subject, said OOH display device including an interaction detector, said interaction detector being configured to detect at least one instance of an interaction between said OOH display device and a subject and provide interaction data based at least in part on said detection, said input mechanism is configured to accept input signals from a subject, and said display controller device is configured to accept data from said OOH display device and said input device;
displaying interactive content on said OOH display device to said subject;
receiving data from at least one of said OOH display device and said input mechanism device at said data processing and routing mechanism in response to said interactive content;
relaying said data to said display controller device; and
changing said interactive content on said OOH display device in response to said data.

19. The method of claim 18, further comprising processing said data received from at least one of said OOH display device and said input mechanism device at said data processing and routing mechanism in response to said interactive content with said data processing and routing mechanism prior to said relaying, whereby at least a portion of said data relayed to said display control device has been processed by said data processing and routing mechanism.

20. The method of claim 18, further comprising receiving data from said display controller device and relaying said data received from said controller device to said OOH display device, and changing said interactive content in response to receiving said data at said OOH display device.
